(19) United States
(12) Patent Application Publication
(10) Pub. No.: US 2026/0277473 A1
(43) Pub. Date: Sep. 17, 2026

(54) ENHANCED REFRESH

(71) Applicant: Rambus Inc., San Jose, CA (US)

(72) Inventors: Thomas VOGELSANG, Jericho, VT (US); Steven C. WOO, Saratoga, CA (US)

(21) Appl. No.: 19/555,116

(22) Filed: Mar. 3, 2026

Related U.S. Application Data
(60) Provisional application No. 63/772,489, filed on Mar. 15, 2025.
(60) Provisional application No. 63/874,905, filed on Sep. 3, 2025.
(60) Provisional application No. 63/928,656, filed on Dec. 1, 2025.
(60) Provisional application No. 63/934,064, filed on Dec. 8, 2025.

(51) Int. Cl. G06F 3/06

(52) U.S. Cl. CPC G06F 3/0656; G06F 3/0604; G06F 3/0673

(57) ABSTRACT

DRAM memory array rows are mapped to at least two contiguous logical address ranges and where a first range (weak rows) is refreshed more frequently than a second range (normal rows). An increased refresh-command cadence and modified row refresh sequence allows the weak cell range to be refreshed multiple times over the retention interval. The number of rows refreshed per refresh command is increased for the weak cell range. A controller may issue ACTIVATE/PRECHARGE sequences over the weak cell range to increase the number of refreshes of the weak cell range independently of the internal device refresh counter. Per row activation counters for each row may use two or more thresholds to trigger refresh management commands based on their vicinity to weak rows. Per row metadata may be configured to determine a row-by-row PRAC threshold based on a row's vicinity to a weak row.

### BRIEF DESCRIPTION OF THE DRAWINGS

FIG. 1 is a block diagram illustrating a memory system.

FIG. 2 is a diagram illustrating an example logical-to-physical address mapping of weak rows.

FIGS. 3A-3B are diagrams illustrating example logical row address refresh sequences.

FIG. 4 is a block diagram illustrating a memory system.

FIG. 5 is a block diagram illustrating a memory system with row hammer mitigation.

FIG. 6 is a flowchart illustrating a method of operating a memory device.

FIG. 7 is a flowchart illustrating a method of refreshing rows.

FIG. 8 is a flowchart illustrating a method of operating a memory controller.

FIG. 9 is a flowchart illustrating a method of mitigating enhanced refresh effects on row hammer.

FIG. 10 is a block diagram of a processing system.

### DETAILED DESCRIPTION OF THE EMBODIMENTS

The rows of a dynamic random access memory (DRAM) device may comprise rows that retain their data over a standardized/specified retention interval (refresh interval—e.g., 32 ms), and those that need refreshing more often (weak rows). A retention interval as used herein denotes a period over which a DRAM ordinarily must refresh each row of a bank at least once to meet retention requirements (e.g., 32 ms in an illustrative device), and a baseline number of refresh commands is the number of REF commands needed by a device to refresh all rows at a nominal rate over such interval. In an embodiment, rather than discarding a device with more weak rows than can be replaced with spare rows, differentiated refresh of DRAM rows where the weak rows are refreshed more often (e.g., 2×) is implemented. Rows are mapped to at least two contiguous logical address ranges and where a first range (weak rows) is refreshed more frequently than a second range (normal rows).

In an embodiment, an increased refresh-command cadence and modified row refresh sequence allows the weak cell range to be refreshed multiple times over the retention interval. In another embodiment, the number of rows refreshed per refresh command is increased for the weak cell range. In another embodiment, a controller may issue ACTIVATE/PRECHARGE (ACT/PRE) sequences over the weak cell range to increase the number of refreshes of the weak cell range independently of the internal device refresh counter. Per row access counters (PRAC) for each row may use two or more thresholds to trigger refresh management commands (RFMs) based on their vicinity to weak rows. Per row metadata may be configured to determine a row-by-row PRAC threshold based on a row's vicinity to a weak row(s).

The descriptions and embodiments disclosed herein may be made with references to DRAM memory devices. This, however, should be understood to be a first example. Other example memory technologies include, but are not limited to static random access memory (SRAM), non-volatile memory (such as flash), conductive bridging random access memory (CBRAM—a.k.a., programmable metallization cell-PMC), resistive random access memory (a.k.a., RRAM or ReRAM), magnetoresistive random-access memory (a.k.a., MRAM), Spin-Torque Transfer (a.k.a., STT-MRAM), phase change memory (a.k.a., PCM), ferroelectric random access memory (a.k.a., FeRAM, or FRAM), and the like, and/or combinations thereof. Accordingly, it should be understood that in the disclosures and/or descriptions given herein, these aforementioned technologies may be substituted for, included with, and/or encompassed within, references to memory IC die, memory devices, memory, DRAM, DRAM devices, memory arrays, and/or DRAM arrays made herein.

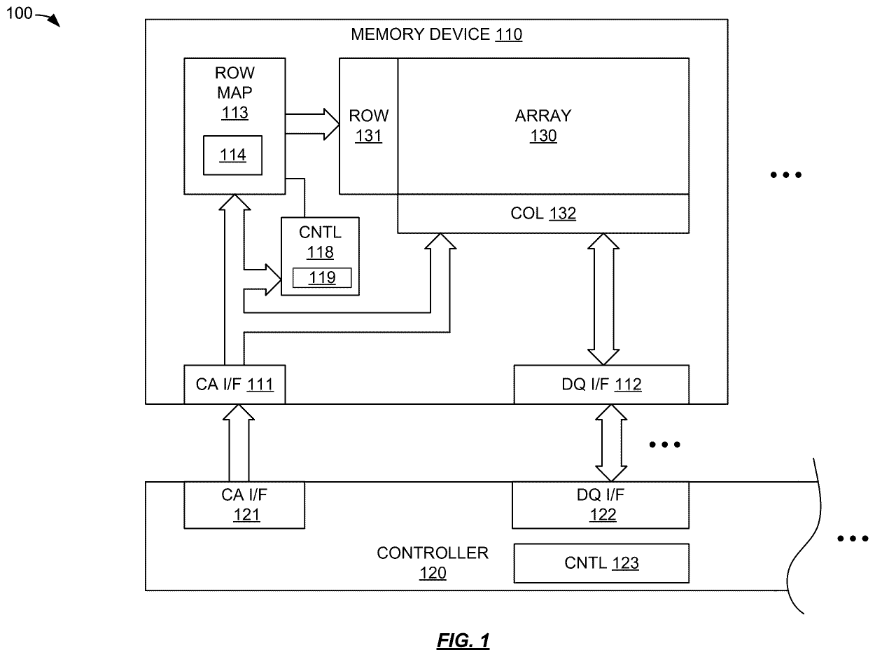

FIG. 1 is a block diagram illustrating a memory system. In FIG. 1, memory system 100 comprises memory device 110 and memory controller 120. Memory device 110 includes command/address (CA) interface 111, data (DQ) interface 112, row address mapping 113, memory array 130, row circuitry 131, column circuitry 132, and control circuitry 118. Row address mapping 113 includes configuration information 114. Configuration information 114 may be or include compressed mapping information such as arithmetic coding, delta-coding, Huffman coding, and/or a linear filter. Control circuitry 118 includes refresh sequence control circuitry 119. Controller 120 includes CA interface 121, DQ interface 122, and refresh control circuitry 125.

Controller 120 and memory device 110 may be integrated circuit type devices, such as are commonly referred to as “chips”. A memory controller, such as controller 120, manages the flow of data going to and from memory devices and/or memory modules. Memory device 110 may be a standalone device, or may be a component of a memory module such as a DIMM module used in servers. In an embodiment, memory device 110 may be a device that adheres to, or is compatible with, a dynamic random access memory (DRAM) specification. In an embodiment, memory device 110 may be, or comprise, a device that is or includes other memory device technologies and/or specifications. A memory controller can be a separate, standalone chip, or integrated into another chip. For example, a memory controller 120 may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect. In addition, memory controller functionality may be disposed on a separate Input/Output (I/O) die along with the transmitter/receiver circuits that interface to the memory device. Such an I/O die may include other types of I/O interfaces, as well as one or more chiplet interfaces that communicate with one or more respective CPU chiplet dies. The I/O die and CPU chiplet dies may be co-packaged together and coupled to one-another via a silicon interposer.

CA interface 121 of controller 120 is operatively coupled to CA interface 111 of memory device 110. CA interface 121 is operatively coupled to CA interface 111 to communicate commands and addresses (e.g., row and column addresses) from controller 120 to memory device 110. In an embodiment, the commands communicated from controller 120 to memory device 110 include activate commands and an associated external row address. In an embodiment, when in an operational mode, the external row addresses received from controller 120 are selected from a contiguous range of external row addresses (i.e., contiguous row address range). In an embodiment, commands communicated from controller 120 to memory device 110 may include refresh commands-referred to herein as REF. In such an embodiment, the row(s) in array 130 refresh by memory device 110 is determined by refresh sequence control circuitry 119 subject to a logical-to-physical address translation performed by row address mapping 113.

Controller 120 is operatively coupled to memory device 110 via DQ interface 122 and DQ interface 112. Controller 120 and memory device 110 are operatively coupled via DQ interface 122 and DQ interface 112 to bidirectionally communicate data. Memory device 110 may store (e.g., in memory array 130) and retrieve (e.g., from memory array 130) data communicated via DQ interface 122 and DQ interface 112.

CA interface 111 of memory device 110 is operatively coupled to array 130. In an embodiment, row addresses received via CA interface 111 (a.k.a., external row addresses) are operatively coupled to primary memory array 130 via row address mapping 113 and row circuitry 131 (e.g., row address decoders, buffers, etc.) In another embodiment, row addresses received via CA interface 111 are operatively coupled to primary memory array 130 via row circuitry 131 without being subject to remapping by row address mapping 113. Column addresses received via CA interface 111 are operatively coupled to memory array 130 via column circuitry 132 (e.g., column address decoders, buffers, etc.).

In an embodiment, refresh sequence control circuitry 119 generates internal logical row addresses (e.g., associated with REF commands) and provides the logical row addresses to row address mapping 113. Based on configuration information 114 (e.g., mode programmed register value, programmed fuses, nonvolatile memory array, etc.), row address mapping 113 maps logical row addresses to internal primary memory array 130 row addresses that are provided to row circuitry 131. Row address mapping 113 maps the logical row addresses from refresh sequence control circuitry 119 to internal physical row addresses to refresh the row(s) addressed by internal physical row addresses.

In an embodiment, row address mapping 113 is configured to map the physical addresses of weak rows (i.e., rows that need to be refreshed more often than the specified retention interval) of a bank to a first contiguous logical address range (a.k.a., weak row logical address range). In an embodiment, the mapping of weak rows by row address mapping 113 may be to a fixed, preselected, contiguous logical address range (e.g., highest one-quarter, highest one-eighth, lowest one-quarter, middle one-eighth, etc.) for each bank. Because there may be different numbers of weak rows in different banks, mapping is done by row address mapping 113 on a bank-by-bank basis. Each bank may have different numbers of weak rows. Thus, it should be understood that not all of the rows in the weak row logical address range may be weak rows. For example, some rows in the weak row logical address range may have logical addresses that match their physical address (i.e., are “unmapped”) and/or are mapped to other locations in the weak row logical address range. Not all of the rows in the weak row logical address range may be weak rows because, for example, the weak row address range was greater than the number of weak rows in a bank.

In an embodiment, row address mapping 113 is configured to map the physical addresses of most normal rows (i.e., rows that are to be using the specified retention interval) of a bank to a second contiguous logical address range (a.k.a., normal row logical address range) such that the second contiguous logical address range only includes rows that are to use the specified retention interval. In an embodiment, the mapping of normal rows by row address mapping 113 to the normal row logical address range may be to a fixed, preselected, contiguous logical address range that does not overlap with the weak row logical address range (e.g., lowest three-quarters with weak rows mapped to the highest one-quarter, highest seven-eighths with weak rows mapped to the highest one-eighth, etc.) for each bank. In an embodiment, these ranges are the same, fixed, regions for each bank. In an embodiment, these ranges may vary bank-to-bank.

In an embodiment, refresh sequence control circuitry 119 issues refreshes to the logical row addresses in the weak row logical address range more often than refresh sequence control circuitry 119 issues refreshes to logical row addresses in the normal row logical address range. For example, refresh sequence control circuitry 119 may issue refreshes to the logical row addresses in the weak row logical address range twice as often as refresh sequence control circuitry 119 issues refreshes to logical row addresses in the normal row logical address range—which are issued at a baseline rate (e.g., each row at least once every 32 ms).

In an embodiment, the timing and frequency of refreshes are controlled by REF commands received from controller 120. Thus, in order for refresh sequence control circuitry 119 to issue refreshes to the logical row addresses in the weak row logical address range more often than refresh sequence control circuitry 119 issues refreshes to logical row addresses in the normal row logical address range, the number of REF commands issued by controller 120 to memory device 110 is increased when compared to the baseline rate/cadence of issuing REF commands. For example, for refresh sequence control circuitry 119 to issue refreshes to the logical row addresses in the weak row logical address range twice as often as refresh sequence control circuitry 119 issues refreshes to logical row addresses in the normal row logical address range, controller 120 may issue, per retention interval, the baseline number of REF commands plus an additional number of REF commands that is equal to (or greater than) the number of logical addresses in the weak row logical address range.

In another embodiment, rather than increasing the number of REF commands issued by controller 120 to memory device 110, refresh sequence control circuitry 119 may, increase the number of rows refreshed per REF command. For example, refresh sequence control circuitry 119 may increase the number of wordlines refreshed per bank in response to a single REF command from two rows to three and then sequence the logical row addresses refreshed to ensure that the weak row logical address range rows are refreshed more often (e.g., 2×) than the normal row logical address range rows. For example, for a certain range of normal logical row addresses, in response to REF commands, refresh sequence control circuitry 119 may issue two refreshes to rows in the normal logical row address range, and an additional refresh to the weak row logical address range (e.g., at a fixed offset from one the rows in the normal logical row address range being refreshed). Outside of that range, including the weak row logical address range, refresh sequence control circuitry 119 may only issue the two refreshes to rows in the current (weak or normal) logical row address range.

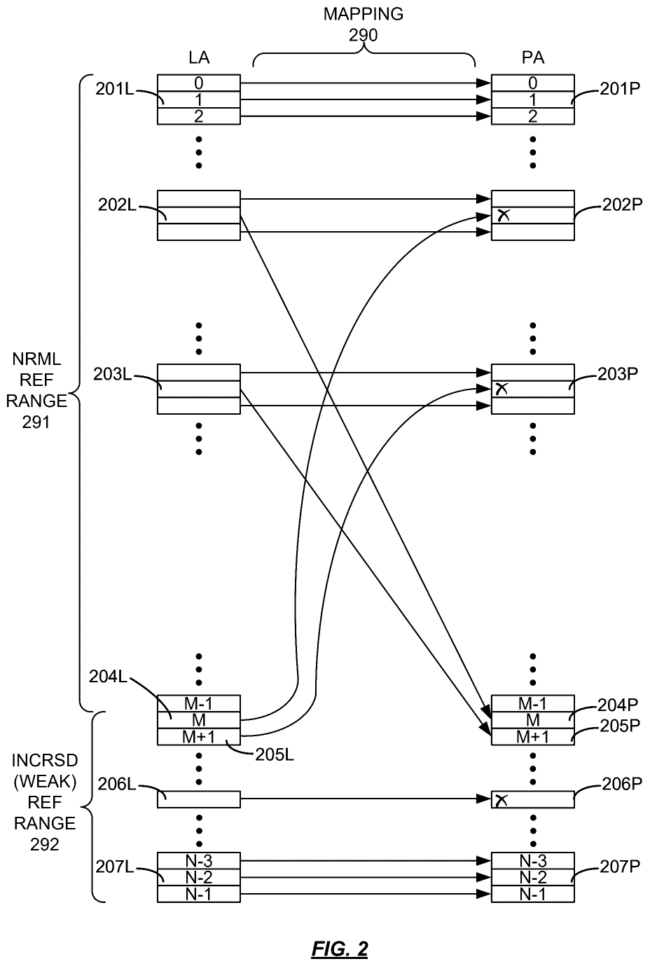

FIG. 2 is a diagram illustrating an example logical-to-physical address mapping of weak rows. FIG. 2 may be illustrative of a logical-to-physical address mapping configuration/strategy implemented by, for example, row address mapping 113 for the mapping of logical addresses received from controller 120 and/or produced by refresh sequence control circuitry 119 to physical row addresses in array 130. In FIG. 2, a logical row address range of N number of row addresses is illustrated mapping to an internal physical row address range (e.g., 64k, 128k, etc.) of N number of row addresses. The N number of logical row addresses are divided into M number of rows in a normal row logical address range 291 and N−M number of rows in a weak row logical address range 292. Also illustrated in FIG. 2 are specific example logical row addresses 201L-207L within the N number of logical row addresses and corresponding physical row addresses 201P-207P within the N number of physical row addresses.

In example of FIG. 2, physical row address 201P corresponds to a normal (i.e., not weak—illustrated by the lack of an “X” in the physical row associated with physical row address 201P) row and mapping 290 is illustrated as configured to map logical row address 201L to physical row address 201P. Physical row address 202P corresponds to a weak row and is thus illustrated with an “X” in the physical row associated with physical row address 202P. Based on physical row address 202P corresponding to a weak row, mapping 290 is illustrated as configured to map weak row logical address M 204L to physical row address 202P. Based on physical row address 202P being mapped to map weak row logical address M 204L, in FIG. 2, mapping 290 is illustrated as configured to map logical row address 202L to physical row address M 204P. Similarly, physical row address 203P corresponds to a weak row and is thus illustrated with an “X” in the physical row associated with physical row address 203P. Based on physical row address 203P corresponding to a weak row, mapping 290 is illustrated as configured to map weak row logical address M+1 205L to physical row address 203P. Based on physical row address 203P being mapped to map weak row logical address M+1 204L, in FIG. 2, mapping 290 is illustrated as configured to map logical row address 2031 to physical row address M+1 205P.

Also in FIG. 2, physical row address 206P corresponds to a weak row and is thus illustrated with an “X” in the physical row associated with physical row address 206P. Based on physical row address 206P corresponding to a weak row, and physical row address 206P corresponding to a logical row address that is in weak row logical address range 292, mapping 290 is illustrated as configured to map weak row logical address 206L to physical row address 206P. Also in FIG. 2, physical row address N−2 207P corresponds to a normal row and thus is not illustrated with an “X” in the physical row associated with physical row address N−2 207P. However, mapping 290 is illustrated as configured to map weak row logical address N−2 207L to physical row address N−2 207P. This may have occurred, for example, because there were fewer than N−M weak rows and thus one or more logical addresses in weak row logical address range 292 were not needed for the mapping of a physical row address into weak row logical address range 292.

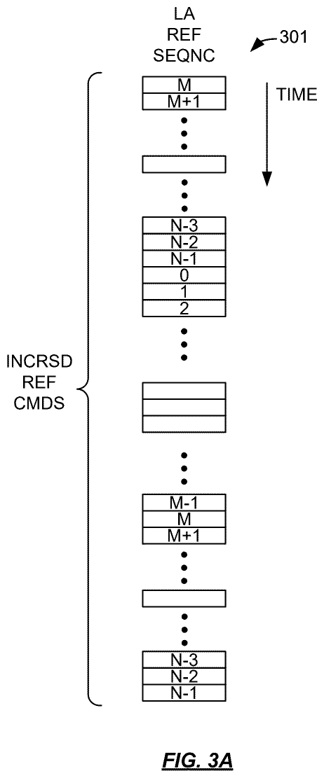

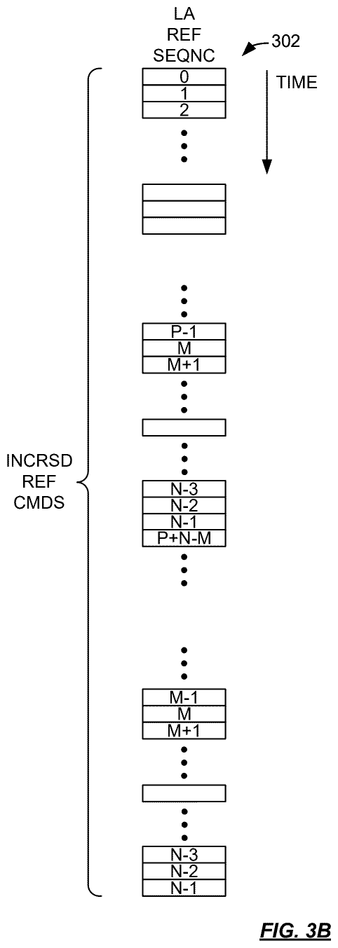

FIG. 3A is a diagram illustrating a first example logical row address refresh sequence. Logical row address refresh sequence 301 of FIG. 3A may be performed, for example, within a retention interval in order to refresh weak rows more often than normal rows. In FIG. 3A, logical row address refresh sequence 301 begins with refreshing weak row logical addresses M through N−1, in ascending order from M to N−1. Logical row address refresh sequence 301 then refreshes normal row addresses 0 to M−1, in ascending order from 0 to M−1. Finally, before repeating, logical row address refresh sequence 301 refreshes weak row logical addresses M through N−1. Thus, over the span of a retention interval, the physical rows associated with the weak row logical addresses from M to N−1 would be refreshed twice as often as the physical rows associated with the weak row logical addresses from 0 to M−1.

FIG. 3B is a diagram illustrating a second example logical row address refresh sequence. Logical row address refresh sequence 302 of FIG. 3B may be performed, for example, within a retention interval in order to refresh weak rows more often than normal rows. In FIG. 3B, logical row address refresh sequence 302 begins with normal row logical addresses 0 through P−1, in ascending order from 0 to P−1. Logical row address refresh sequence 301 then refreshes normal row addresses P+N−M to M−1, in ascending order from P+N−M to M−1. Logical row address refresh sequence 302 then refreshes weak row logical addresses M through N−1, in ascending order from M to N−1. Finally, before repeating, logical row address refresh sequence 302 refreshes weak row logical addresses M through N−1 in ascending order form M to N−1. Thus, over the span of a retention interval, the physical rows associated with the weak row logical addresses from M to N−1 would be refreshed twice as often as the physical rows associated with the weak row logical addresses from 0 to M−1. In an embodiment, P may be selected in order to place maximum distance between the two refreshes of weak row logical address range M to N−1. In other words, in an embodiment, two or more instances of weak row logical address range refreshes in a logical row address refresh sequence may be placed in the logical row address refresh sequence such that they are substantially maximally-dispersed (and/or evenly interleaved with) other instances of the at least two weak row logical address range refreshes.

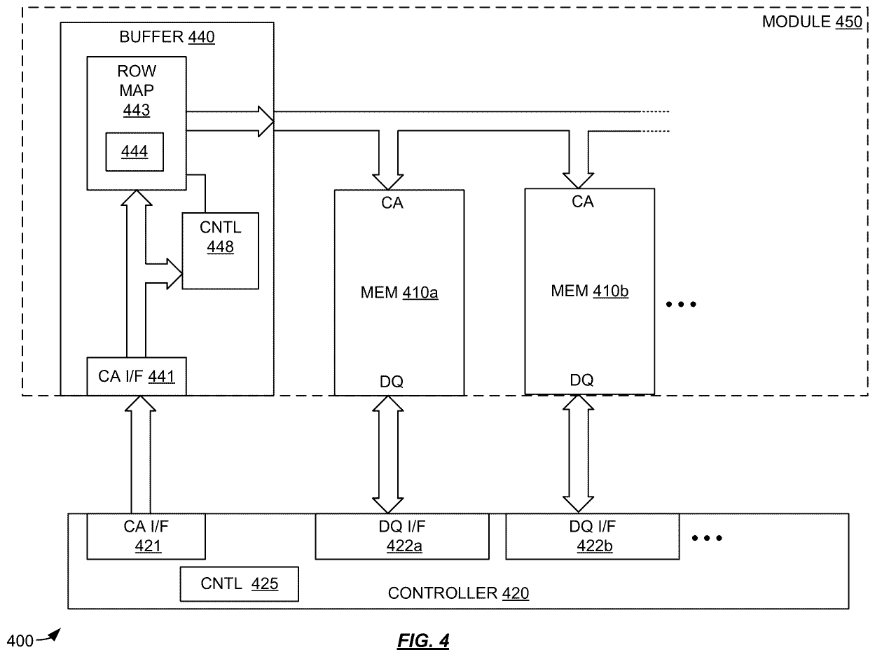

FIG. 4 is a block diagram illustrating a memory system. In FIG. 4, memory system 400 comprises memory module 450 and memory controller 420. Memory module 450 include buffer device 440 and a plurality of memory devices 410a-410b. Buffer device 440 includes command/address (CA) interface 441, row address mapping 443, and control circuitry 448. Row address mapping 443 includes configuration information 444. Configuration information 444 may be or include compressed mapping information such as arithmetic coding, delta-coding, Huffman coding, and/or a linear filter. Memory devices 410a-410b each include command/address interfaces and data (DQ) interfaces. Controller 420 includes CA interface 421, DQ interface 422a, and refresh control circuitry 425.

Controller 420, buffer device 440, and memory devices 410a-410b may be integrated circuit type devices, such as are commonly referred to as “chips”. A memory controller, such as controller 420, manages the flow of data going to and from memory devices and/or memory modules. Memory module 450 may be a DIMM module such as is used in laptops, desktops, and/or servers. In an embodiment, memory devices 410a-410b may be devices that adhere to, or are compatible with, a dynamic random access memory (DRAM) specification and/or DIMM specification (e.g., DDR5, etc.). In an embodiment, memory devices 410a-410b may be, or comprise, a device that is or includes other memory device technologies and/or specifications. A memory controller can be a separate, standalone chip, or integrated into another chip. For example, a memory controller 420 may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect. In addition, memory controller functionality may be disposed on a separate Input/Output (I/O) die along with the transmitter/receiver circuits that interface to the memory device. Such an I/O die may include other types of I/O interfaces, as well as one or more chiplet interfaces that communicate with one or more respective CPU chiplet dies. The I/O die and CPU chiplet dies may be co-packaged together and coupled to one-another via a silicon interposer.

CA interface 421 of controller 420 is operatively coupled to CA interface 441 of buffer device 440. CA interface 421 is operatively coupled to CA interface 441 to communicate commands and addresses (e.g., row and column addresses) from controller 420 to buffer device 440 for transmission, after logical-to-physical row address mapping by row address mapping 443, to memory device 410a-410b via their respective CA interfaces. In an embodiment, the commands communicated from controller 420 to buffer device 440 (and therefore also to memory devices 410a-410b) include activate commands (ACT) and precharge commands (PRE). In an embodiment, when in an operational mode, the row addresses received from controller 420 are selected from a contiguous range of row addresses (i.e., a contiguous row address range). In an embodiment, commands communicated from controller 420 to buffer device 440 (and therefore also to memory devices 410a-410b) may include REF commands. In an embodiment, the row(s) in memory devices 410a-410b to be refreshed in response to a REF command are determined by refresh control circuitry internal to memory devices 410a-410b.

Controller 420 is operatively coupled to memory device 410a via DQ interface 422a and the DQ interface of memory device 410a. Controller 420 is operatively coupled to memory device 410b via DQ interface 422b and the DQ interface of memory device 410b. Controller 420 and memory devices 410a-410b are operatively coupled via DQ interfaces 422a-422b to bidirectionally communicate data. Memory devices 410a-410b may store and retrieve data communicated via DQ interfaces 422a-422b.

CA interface 441 of buffer device 440 is operatively coupled to row address mapping 443. In an embodiment, row addresses received via CA interface 441 (a.k.a., external row addresses) are operatively coupled to memory devices 410a-410b via row address mapping 443. Column addresses received via CA interface 441 are operatively coupled to memory devices 410a-410b without being mapped by row address mapping 443.

In an embodiment, refresh control circuitry 425, in addition to generating REF commands, generates external logical row addresses for ACT/PRE command sequences that are mapped by row address mapping 443 to physical row addresses that are provided to memory devices 410a-410b. Based on configuration information 444 (e.g., mode programmed register value, programmed fuses, nonvolatile memory array, etc.), row address mapping 443 maps these logical row addresses to row addresses that are provided to memory devices 410a-410b.

In an embodiment, row address mapping 443 is configured to map the physical addresses of weak rows (i.e., rows that need to be refreshed more often than the specified retention interval) of at least one of the memory devices 410a-410b to a first contiguous logical address range (a.k.a., weak row logical address range). In an embodiment, the mapping of weak rows by row address mapping 443 may be to a fixed, preselected, contiguous logical address range (e.g., highest one-quarter, highest one-eighth, lowest one-quarter, middle one-eighth, etc.) for each bank. Because there may be different numbers of weak rows in different banks of memory devices 410a-410b, mapping is done by row address mapping 443 on a bank-by-bank basis.

In an embodiment, row address mapping 443 is configured to map the physical addresses of most normal rows of memory devices 410a-410b to a second contiguous logical address range (a.k.a., normal row logical address range) such that the second contiguous logical address range only includes rows of memory devices 410a-410b that are to use the specified retention interval. In an embodiment, the mapping of normal rows by row address mapping 443 to the normal row logical address range may be to a fixed, preselected, contiguous logical address range that does not overlap with the weak row logical address range (e.g., lowest three-quarters with weak rows mapped to the highest one-quarter, highest seven-eighths with weak rows mapped to the highest one-eighth, etc.) for each bank. In an embodiment, these ranges are the same, fixed, regions for each bank. In an embodiment, these ranges may vary bank-to-bank.

In an embodiment, controller 420 (and refresh control circuitry 425, in particular) issues at least a baseline number of REF commands each retention interval. In addition, at least once every retention interval, controller 420 issues ACT/PRE command sequences to each of the logical row addresses in the first (weak row) logical address range. In this manner, controller 420 ensures that each row in the normal logical address range and the weak row logical address range are refreshed at least once per retention interval by REF commands, and that each row in the weak row logical address range are refreshed at least a second time per retention interval by the ACT/PRE command sequences. Thus, the rows mapped to the weak row logical address range get refresh more often than the rows in the normal row logical address range.

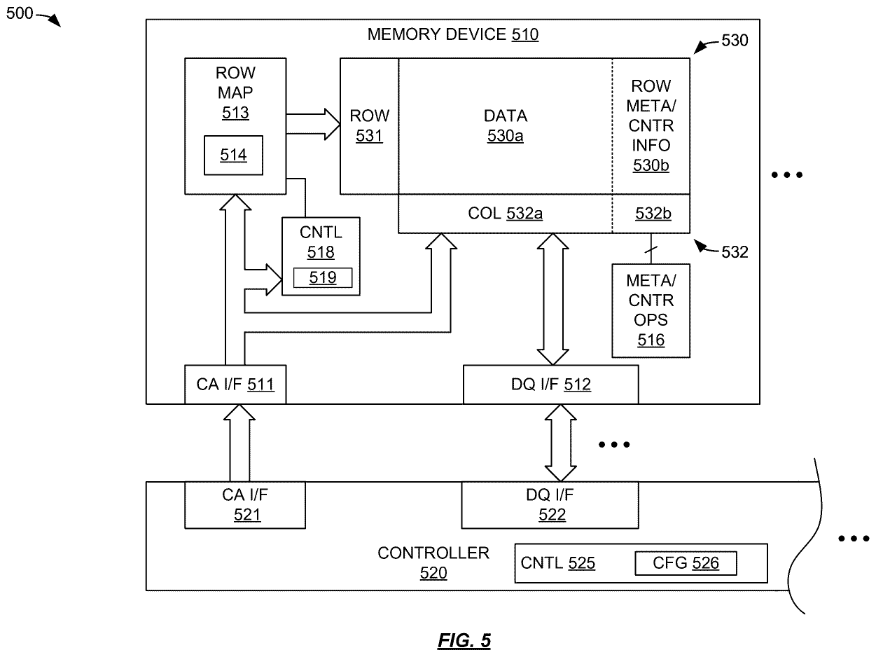

FIG. 5 is a block diagram illustrating a memory system with row hammer mitigation. In FIG. 5, memory system 500 comprises memory device 510 and memory controller 520. Memory device 510 includes command/address (CA) interface 511, data (DQ) interface 512, row address mapping 513, memory array 530, row circuitry 531, column circuitry 532, metadata/counter operations circuitry 515, and control circuitry 518. Row address mapping 513 includes configuration information 514. Configuration information 514 may be or include compressed mapping information such as arithmetic coding, delta-coding, Huffman coding, and/or a linear filter. Control circuitry 518 includes refresh sequence control circuitry 519. Controller 520 includes CA interface 521, DQ interface 522, and refresh control circuitry 525. The rows and columns of memory array 530 may be organized into rows and columns of memory array tiles (MATs).

Controller 520 and memory device 510 may be integrated circuit type devices, such as are commonly referred to as “chips”. A memory controller, such as controller 520, manages the flow of data going to and from memory devices and/or memory modules. Memory device 510 may be a standalone device, or may be a component of a memory module such as a DIMM module used in servers. In an embodiment, memory device 510 may be a device that adheres to, or is compatible with, a dynamic random access memory (DRAM) specification. In an embodiment, memory device 510 may be, or comprise, a device that is or includes other memory device technologies and/or specifications. A memory controller can be a separate, standalone chip, or integrated into another chip. For example, a memory controller 520 may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect. In addition, memory controller functionality may be disposed on a separate Input/Output (I/O) die along with the transmitter/receiver circuits that interface to the memory device. Such an I/O die may include other types of I/O interfaces, as well as one or more chiplet interfaces that communicate with one or more respective CPU chiplet dies. The I/O die and CPU chiplet dies may be co-packaged together and coupled to one-another via a silicon interposer.

CA interface 511 of memory device 510 is operatively coupled to row circuitry 531 (optionally via row address mapping 513), column circuitry 532, and metadata/counter operations circuitry 516. CA interface 511 is operatively coupled to row circuitry 531 to at least to activate rows in memory array 530. CA interface 511 is operatively coupled to column circuitry 532 to at least sense values from activated rows, and to decode and provide the values of selected columns to other circuitry of memory device 510 (e.g., metadata/counter operations circuitry 516, DQ interface 512, etc.)

Memory array 530 of memory device 510 is logically subdivided into column groups 530a-530b (or MAT groups, columns of MATs, sections, assignments, and/or associations). Column group 530a is to store data provided by controller 520. Metadata/counter information field 530b is to store metadata (either provided by controller 520 or internally generated/updated) associated with the rows in memory array 530. Thus, it should be understood that each row of memory array 530 may be viewed as comprising two “fields”—a data field and a metadata field. In an embodiment, the metadata field of a row may be used to store a counter value or other information related to the row it is associated with and/or resides in (i.e., is activated in response to the same row address as the rest of the row—a.k.a., metadata/counter field). At least how and when the metadata values associated with the rows of memory array 530 are used and/or updated is based on the configuration of metadata/counter operations circuitry 516 provided by controller 520.

CA interface 521 of controller 520 is operatively coupled to CA interface 511 of memory device 510. CA interface 521 is operatively coupled to CA interface 511 to communicate commands and addresses (e.g., row and column addresses) from controller 520 to memory device 510. In an embodiment, the commands communicated from controller 520 to memory device 510 include activate commands and an associated external row address. In an embodiment, when in an operational mode, the external row addresses received from controller 520 are selected from a contiguous range of external row addresses (i.e., contiguous row address range). In an embodiment, commands communicated from controller 520 to memory device 510 may include refresh commands—referred to herein as REF. In such an embodiment, the row(s) in array 530 refresh by memory device 510 is determined by refresh sequence control circuitry 519 subject to a logical-to-physical address translation performed by row address mapping 513.

Controller 520 is operatively coupled to memory device 510 via DQ interface 522 and DQ interface 512. Controller 520 and memory device 510 are operatively coupled via DQ interface 522 and DQ interface 512 to bidirectionally communicate data. Memory device 510 may store (e.g., in memory array 530) and retrieve (e.g., from memory array 530) data communicated via DQ interface 522 and DQ interface 512.

CA interface 511 of memory device 510 is operatively coupled to array 530. In an embodiment, row addresses received via CA interface 511 (a.k.a., external row addresses) are operatively coupled to primary memory array 530 via row address mapping 513 and row circuitry 531 (e.g., row address decoders, buffers, etc.) In another embodiment, row addresses received via CA interface 511 are operatively coupled to primary memory array 530 via row circuitry 531 without being subject to remapping by row address mapping 513. Column addresses received via CA interface 511 are operatively coupled to memory array 530 via column circuitry 532 (e.g., column address decoders, buffers, etc.).

In an embodiment, refresh sequence control circuitry 519 generates internal logical row addresses (e.g., associated with REF commands) and provides the logical row addresses to row address mapping 513. Based on configuration information 514 (e.g., mode programmed register value, programmed fuses, nonvolatile memory array, etc.), row address mapping 513 maps logical row addresses to internal primary memory array 530 row addresses that are provided to row circuitry 531. Row address mapping 513 maps the logical row addresses from refresh sequence control circuitry 519 to internal physical row addresses to refresh the row(s) addressed by internal physical row addresses.

In an embodiment, row address mapping 513 is configured to map the physical addresses of weak rows (i.e., rows that need to be refreshed more often than the specified retention interval) of a bank to a first contiguous logical address range (a.k.a., weak row logical address range). In an embodiment, the mapping of weak rows by row address mapping 513 may be to a fixed, preselected, contiguous logical address range (e.g., highest one-quarter, highest one-eighth, lowest one-quarter, middle one-eighth, etc.) for each bank. Because there may be different numbers of weak rows in different banks, mapping is done by row address mapping 513 on a bank-by-bank basis. Each bank may have different numbers of weak rows. Thus, it should be understood that not all of the rows in the weak row logical address range may be weak rows. For example, some rows in the weak row logical address range may have logical addresses that match their physical address (i.e., are “unmapped”) and/or are mapped to other locations in the weak row logical address range. Not all of the rows in the weak row logical address range may be weak rows because, for example, the weak row address range was greater than the number of weak rows in a bank.

In an embodiment, row address mapping 513 is configured to map the physical addresses of most normal rows (i.e., rows that are to be using the specified retention interval) of a bank to a second contiguous logical address range (a.k.a., normal row logical address range) such that the second contiguous logical address range only includes rows that are to use the specified retention interval. In an embodiment, the mapping of normal rows by row address mapping 513 to the normal row logical address range may be to a fixed, preselected, contiguous logical address range that does not overlap with the weak row logical address range (e.g., lowest three-quarters with weak rows mapped to the highest one-quarter, highest seven-eighths with weak rows mapped to the highest one-eighth, etc.) for each bank. In an embodiment, these ranges are the same, fixed, regions for each bank. In an embodiment, these ranges may vary bank-to-bank.

In an embodiment, refresh sequence control circuitry 519 issues refreshes to the logical row addresses in the weak row logical address range more often than refresh sequence control circuitry 519 issues refreshes to logical row addresses in the normal row logical address range. For example, refresh sequence control circuitry 519 may issue refreshes to the logical row addresses in the weak row logical address range twice as often as refresh sequence control circuitry 519 issues refreshes to logical row addresses in the normal row logical address range—which are issued at a baseline rate (e.g., each row at least once every 32 ms).

In an embodiment, the timing and frequency of refreshes are controlled by REF commands received from controller 520. Thus, in order for refresh sequence control circuitry 519 to issue refreshes to the logical row addresses in the weak row logical address range more often than refresh sequence control circuitry 519 issues refreshes to logical row addresses in the normal row logical address range, the number of REF commands issued by controller 520 to memory device 510 is increased when compared to the baseline rate/cadence of issuing REF commands. For example, for refresh sequence control circuitry 519 to issue refreshes to the logical row addresses in the weak row logical address range twice as often as refresh sequence control circuitry 519 issues refreshes to logical row addresses in the normal row logical address range, controller 520 may issue, per retention interval, the baseline number of REF commands plus an additional number of REF commands that is equal to (or greater than) the number of logical addresses in the weak row logical address range.

In another embodiment, rather than increasing the number of REF commands issued by controller 520 to memory device 510, refresh sequence control circuitry 519 may, increase the number of rows refreshed per REF command. For example, refresh sequence control circuitry 519 may increase the number of wordlines refreshed per bank in response to a single REF command from two rows to three and then sequence the logical row addresses refreshed to ensure that the weak row logical address range rows are refreshed more often (e.g., 2×) than the normal row logical address range rows. For example, for a certain range of normal logical row addresses, in response to REF commands, refresh sequence control circuitry 519 may issue two refreshes to rows in the normal logical row address range, and an additional refresh to the weak row logical address range (e.g., at a fixed offset from one the rows in the normal logical row address range being refreshed). Outside of that range, including the weak row logical address range, refresh sequence control circuitry 519 may only issue the two refreshes to rows in the current (weak or normal) logical row address range.

In an embodiment, metadata/counter operations circuitry 516 may be configured to use in-DRAM metadata/counter information fields 530b of array 530 to, for example, maintain a counter (e.g., per-row activation counter—PRAC) for row-hammer or row-press tracking. For example, metadata/counter operations circuitry 516 may be configured to update the metadata/counter information fields 530b of array 530 to count the number of activations of each row of array 530. If the metadata/counter information field 530b of an activated row is greater than a configured (e.g., maximum activation threshold) value (e.g., in control circuitry 518), then a row address and counter value may be communicated to controller 520.

Row hammer is a vulnerability in dynamic random-access memory (DRAM) where repeatedly activating (or “hammering”) a row of memory cells can cause bit flips in adjacent rows. This occurs due to electrical interference: high-frequency activations of a row can induce charge leakage in neighboring rows, potentially altering stored data without directly accessing those rows. This phenomenon exploits the physical proximity and charge sensitivity of high-density DRAM cells.

In another example, if the activated row counter value in the metadata/counter information field 530b of an activated row is higher than a configured threshold, metadata/counter operations circuitry 516 may save the current row address and counter value to a register (e.g., in control circuitry 518) and trigger an alert to controller 520. In response to the alert, controller 520 may read the register(s) (e.g., using a mode register read command) that are storing the row address and counter value that met/exceeded the threshold. In another example, controller 520 may, without receiving an alert, periodically read the register circuitry to learn whether an activated row counter value was higher than a configured threshold.

In an embodiment, based on metadata configured by controller 520, metadata/counter information field 530b operates with two different thresholds: a first threshold is assigned to normal rows and a second threshold is assigned to weak rows. In this manner, weak rows are subject to a refresh management command based on the PRAC more often (activation-wise) than normal rows. In addition, the threshold indicators (e.g., 1-2 bits) in metadata/counter information field 530b may be based on whether any neighbor rows in the vicinity (e.g., 1-3 rows) of the subject row are weak rows. Table 1 illustrates example pseudo-code for the operations described herein with respect to the operation of metadata/counter operations circuitry 516 and PRAC.

```
TABLE 1
Update PRAC_Counter;
if (WN == 1) { // metadata indicated at least one neighbor is a weak row
  if (PRAC_Counter ≥ THRESH_WEAK) { // threshold for weak and weak neighbor rows
    Save row address for future RFM operation; // Refresh all neighbors,
```

// including Weak neighbors

```
    PRAC Counter = 0; // Reset PRAC Counter to 0
  }
} else { // All neighbor rows are Good rows
  if (PRAC Counter ≥ THRESH_NORM) { // threshold for normal rows
    Save row address for future RFM operation; // Refresh all neighbors
    PRAC Counter = 0;  // Reset PRAC Counter to 0
  }
                                    }
```

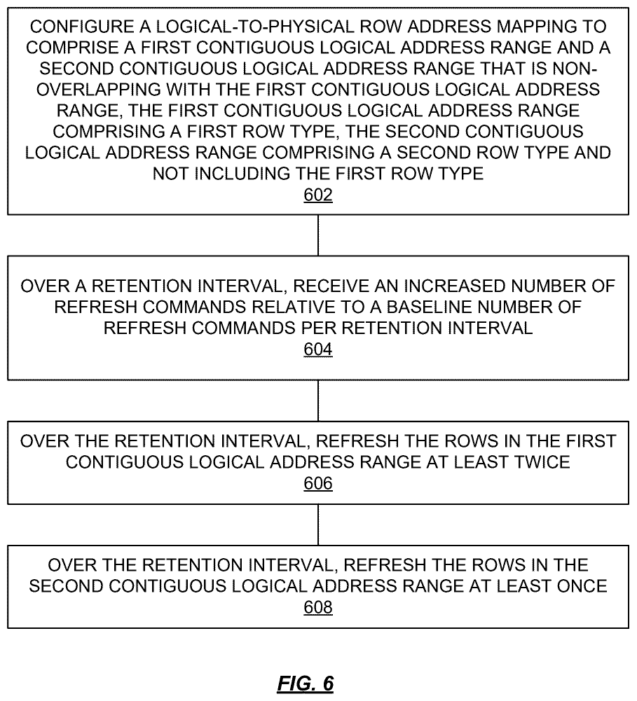

FIG. 6 is a flowchart illustrating a method of operating a memory device. One or more steps illustrated in FIG. 6 may be performed by, for example, system 100, system 400, system 500 and/or their components. A logical-to-physical row address mapping is configured to comprise a first contiguous logical address range and a second contiguous logical address range that is non-overlapping with the first contiguous logical address range, the first contiguous logical address range comprising a first row type, the second contiguous logical address range comprising a second row type and not including the first row type (602). For example, row address mapping 113 (and configuration information 114, in particular) may be configured to map weak rows of memory array 130 to a weak row logical address range (e.g., FIGS. 2, M to N−1) and normal rows to a normal row logical address range (e.g., FIG. 2, 0 to M−1), where the weak row logical address range and the normal row logical address range do not overlap with each other.

Over a retention interval, an increased number of refresh commands relative to a baseline number of refresh commands per retention interval are received (604). For example, memory device 110 may receive, from controller 120, an increased number of REF commands per retention interval in order to allow memory device 110 to refresh the rows in the weak row logical address range at least twice per retention interval, and the rows in the normal row logical address range at least once per retention interval (e.g., FIGS. 3A-3B where controller 120 may issue 2N−M REF commands per retention interval where, in an illustrative mapping, N is the baseline number of REF commands).

Over the retention interval, the rows in the first contiguous logical address range are refreshed at least twice (606). For example, in response to the increased number of REF commands issued by controller 120, refresh sequence control circuitry 119 of memory device 110 may refresh the rows in the weak row logical address range at least twice per retention interval (e.g., FIGS. 3A-3B where logical address refresh sequences 301-302 have two instances of the logical address range M to N−1). Over the retention interval, the rows in the second contiguous logical address range are refreshed at least once (608). For example, in response to the increased number of REF commands issued by controller 120, refresh sequence control circuitry 119 of memory device 110 may refresh the rows in the normal row logical address range at least once per retention interval (e.g., FIGS. 3A-3B where logical address refresh sequences 301-302 have once instance of the logical address range 0 to M−1).

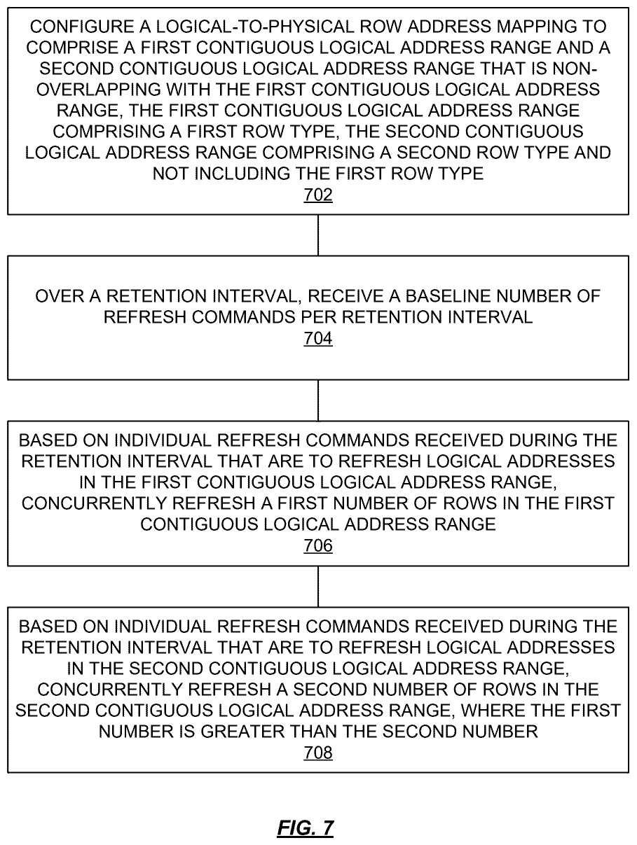

FIG. 7 is a flowchart illustrating a method of refreshing rows. One or more steps illustrated in FIG. 7 may be performed by, for example, system 100, system 400, system 500 and/or their components. A logical-to-physical row address mapping is configured to comprise a first contiguous logical address range and a second contiguous logical address range that is non-overlapping with the first contiguous logical address range, the first contiguous logical address range comprising a first row type, the second contiguous logical address range comprising a second row type and not including the first row type (702). For example, row address mapping 113 (and configuration information 114, in particular) may be configured to map weak rows of memory array 130 to a weak row logical address range (e.g., FIGS. 2, M to N−1) and normal rows to a normal row logical address range (e.g., FIG. 2, 0 to M−1), where the weak row logical address range and the normal row logical address range do not overlap with each other.

Over a retention interval, baseline number of refresh commands per retention interval are received (704). For example, memory device 110 may receive, from controller 120, an baseline number of REF commands in order to allow memory device 110 to perform at least the baseline number of refresh operations per retention interval (e.g., FIG. 2 since there are N logical addresses and N physical addresses, in an illustrative mapping, N is the baseline number of REF commands needed per retention interval).

Based on individual refresh command received during the retention interval that are to refresh logical addresses in the first contiguous logical address range, a first number of rows in the first contiguous address range are refreshed (706). For example, in response to individual REF commands issued by controller 120, refresh sequence control circuitry 119 of memory device 110 may refresh X (e.g., 3) number of rows when refresh sequence control circuitry 119 is cycling through the weak row logical address range at least once per retention interval. Based on individual refresh command received during the retention interval that are to refresh logical addresses in the second contiguous logical address range, a second number of rows in the second contiguous address range are refreshed, where the first number is greater than the second number (706). For example, in response to individual REF commands issued by controller 120, refresh sequence control circuitry 119 of memory device 110 may refresh Y (e.g., 2) number of rows when refresh sequence control circuitry 119 is cycling through the normal row logical address range at least once per retention interval, where X is greater than Y.

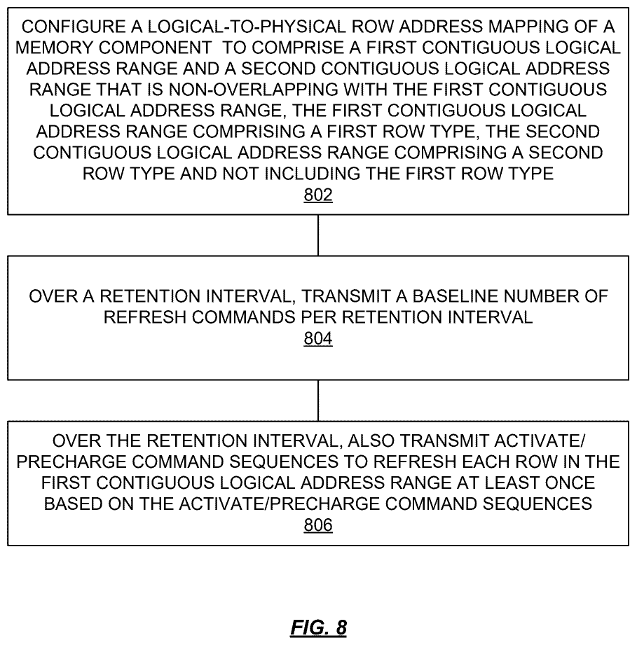

FIG. 8 is a flowchart illustrating a method of operating a memory controller. One or more steps illustrated in FIG. 8 may be performed by, for example, system 100, system 400, system 500 and/or their components. A logical-to-physical row address mapping is configured to comprise a first contiguous logical address range and a second contiguous logical address range that is non-overlapping with the first contiguous logical address range, the first contiguous logical address range comprising a first row type, the second contiguous logical address range comprising a second row type and not including the first row type (802). For example, row address mapping 443 (and configuration information 444, in particular) may be configured, by controller 420, to map rows that are collectively weak rows among memory devices 410a-410b to a weak row logical address range (e.g., FIGS. 2, M to N−1) and normal rows to a normal row logical address range (e.g., FIG. 2, 0 to M−1), where the weak row logical address range and the normal row logical address range do not overlap with each other.

Over a retention interval, baseline number of refresh commands per retention interval are transmitted (804). For example, controller 420 may transmit, to buffer device 440 for relay to memory devices 410a-410b, a baseline number of REF commands in order to allow memory devices 410a-410b to perform at least the baseline number of refresh operations per retention interval (e.g., FIG. 2 since there are N logical addresses and N physical addresses, in an illustrative mapping, N is the baseline number of REF commands needed per retention interval). Over the retention interval, activate/precharge sequences are transmitted to refresh each row in the first contiguous logical address range at least once based on the activate/precharge command sequences (806). For example, controller 420 may transmit, to buffer device 440 for relay to memory devices 410a-410b, a ACT/PRE command sequences directed to each address in the weak cell logical address range in order to have memory devices 410a-410b perform ACT/PRE operations that refresh each row in memory devices 410a-410b that are mapped into the weak cell logical address range by row address mapping 443 (and configuration information 444, in particular).

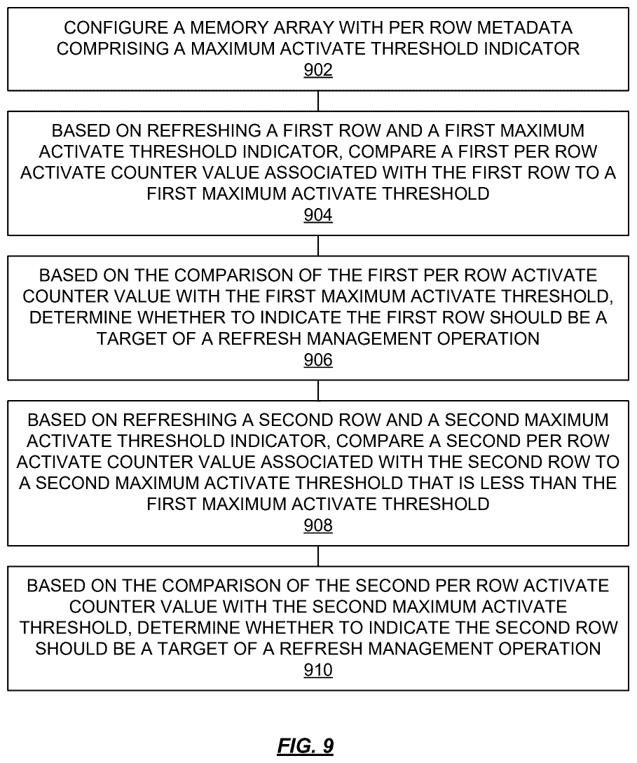

FIG. 9 is a flowchart illustrating a method of mitigating enhanced refresh effects on row hammer. One or more steps illustrated in FIG. 9 may be performed by, for example, system 100, system 400, system 500 and/or their components. A memory array is configured with per row metadata comprising a maximum activate threshold indicator (902). For example, controller 520 may configure, on a row-by-row basis, metadata in metadata/counter information field 530b with an indicator(s) (e.g., weak neighbor indicator—WN bit) of what threshold (e.g., THRESH_WEAK vs. THRESH_NORM, etc.) PRAC count for that row should trigger row hammer mitigation operations/actions (e.g., RFM command).

Based on refreshing a first row and a first maximum active threshold indicator, a first per row activate counter value associated with first row is compared to a first maximum activate threshold (904). For example, based on the weak neighbor indicator (e.g., WN bit) value in the metadata/counter information field 530b of a first row (e.g., a normal row or a normal row not within a certain physical number of rows of a weak row), metadata/counter operations circuitry 516 may compare the PRAC counter in the metadata/counter information field 530b of that first row with a threshold activate count associated with normal rows (e.g., THRESH_NORM). Based on the comparison of the first per row activate counter value with the first maximum activate threshold, it is determined whether to indicate the first row should be a target of a refresh management operation (906). For example, metadata/counter operations circuitry 516 may, based on the comparison of the PRAC counter in the metadata/counter information field 530b of the first row with the threshold activate count associated with normal rows (e.g., THRESH_NORM), determine whether to indicate (e.g., to controller 520) that the first row should be the target of an RFM command.

Based on refreshing a second row and a second maximum active threshold indicator, a second per row activate counter value associated with second row is compared to a second maximum activate threshold that is less than the first maximum activate threshold (908). For example, based on the weak neighbor indicator (e.g., WN bit) value in the metadata/counter information field 530b of a second row (e.g., a weak row or a normal row within a certain physical number of rows of a weak row), metadata/counter operations circuitry 516 may compare the PRAC counter in the metadata/counter information field 530b of that second row with a threshold activate count associated with weak rows that is less than the threshold activate count used for normal rows (e.g., THRESH_WEAK where THRESH_WEAK<THRESH_NORM). Based on the comparison of the second per row activate counter value with the second maximum activate threshold, it is determined whether to indicate the second row should be a target of a refresh management operation (910). For example, metadata/counter operations circuitry 516 may, based on the comparison of the PRAC counter in the metadata/counter information field 530b of the second row with the threshold activate count associated with weak rows (e.g., THRESH_WEAK), determine whether to indicate (e.g., to controller 520) that the second row should be the target of an RFM command.

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of system 100, system 400, and/or system 500, and their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

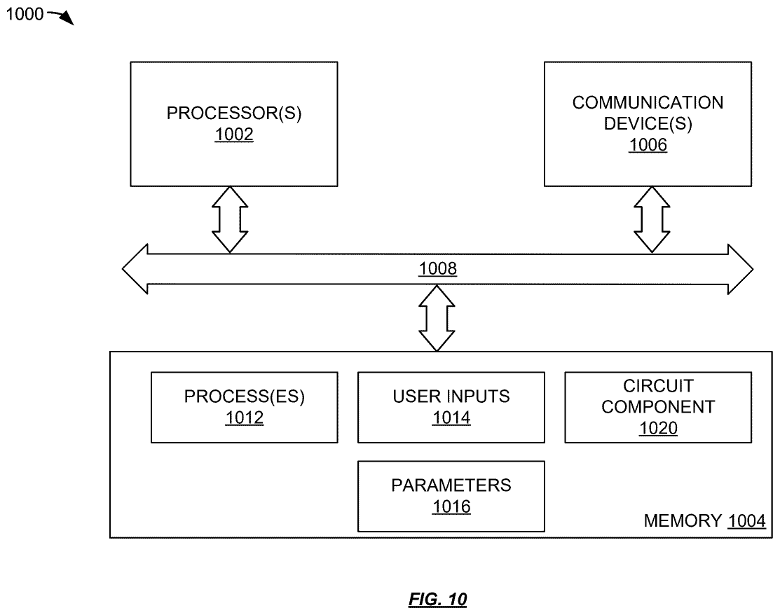

FIG. 10 is a block diagram illustrating one embodiment of a processing system 1000 for including, processing, or generating, a representation of a circuit component 1020. Processing system 1000 includes one or more processors 1002, a memory 1004, and one or more communications devices 1006. Processors 1002, memory 1004, and communications devices 1006 communicate using any suitable type, number, and/or configuration of wired and/or wireless connections 1008.

Processors 1002 execute instructions of one or more processes 1012 stored in a memory 1004 to process and/or generate circuit component 1020 responsive to user inputs 1014 and parameters 1016. Processes 1012 may be any suitable electronic design automation (EDA) tool or portion thereof used to design, simulate, analyze, and/or verify electronic circuitry and/or generate photomasks for electronic circuitry. Representation 1020 includes data that describes all or portions of system 100, system 400, and/or system 500, and their components, as shown in the Figures.

Representation 1020 may include one or more of behavioral, register transfer, logic component, transistor, and layout geometry-level descriptions. Moreover, representation 1020 may be stored on storage media or communicated by carrier waves.

Data formats in which representation 1020 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email.

User inputs 1014 may comprise input parameters from a keyboard, mouse, voice recognition interface, microphone and speakers, graphical display, touch screen, or other type of user interface device. This user interface may be distributed among multiple interface devices. Parameters 1016 may include specifications and/or characteristics that are input to help define representation 1020. For example, parameters 1016 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 1004 includes any suitable type, number, and/or configuration of non-transitory computer-readable storage media that stores processes 1012, user inputs 1014, parameters 1016, and circuit component 1020.

Communications devices 1006 include any suitable type, number, and/or configuration of wired and/or wireless devices that transmit information from processing system 1000 to another processing or storage system (not shown) and/or receive information from another processing or storage system (not shown). For example, communications devices 1006 may transmit circuit component 1020 to another system. Communications devices 1006 may receive processes 1012, user inputs 1014, parameters 1016, and/or circuit component 1020 and cause processes 1012, user inputs 1014, parameters 1016, and/or circuit component 1020 to be stored in memory 1004.

Implementations discussed herein include, but are not limited to, the following examples:

Example 1: A dynamic random access memory (DRAM) device, comprising: a memory array having rows accessed according to a physical row address range, the rows associated with one of a first type of row and a second type of row where the first type of row is to be refreshed more often than the second type of row for reliable operation of the memory array; row address mapping circuitry to map physical addresses of the first type of rows to a first contiguous range of logical row addresses and to map physical addresses of the second type of rows to a second contiguous range of logical row addresses, and to also map external access command addresses to the first contiguous range and the second contiguous range; and refresh address generation circuitry to, responsive to external refresh commands that are greater in number than a baseline number of refresh commands per retention interval, step through the first contiguous range at least twice per retention interval and step through the second contiguous range at least once per retention interval.

Example 2: The DRAM device of example 1, wherein the external access command addresses are associated with at least refresh, activate, and precharge commands.

Example 3: The DRAM device of example 1, wherein the refresh address generation circuitry is to step through a range of logical addresses that includes at least two instances of the first contiguous range.

Example 4: The DRAM device of example 3, wherein a first instance of the of the first contiguous range is inserted into the range of logical addresses that includes at least two instances of the first contiguous range such that the first instance is substantially maximally-dispersed from other instances of the at least two instances of the first contiguous range.

Example 5: The DRAM device of example 3, wherein the at least two instances of the first contiguous range are substantially evenly interleaved across the range of logical addresses that includes at least two instances of the first contiguous range.

Example 6: The DRAM device of example 1, wherein the memory array includes per row activation counters.

Example 7: The DRAM device of example 6, wherein the memory array includes per row metadata to indicate whether a row has a physically adjacent row that is in the first contiguous range.

Example 8: The DRAM device of example 7, wherein different row activation counter thresholds are used for rows indicated to have a physically adjacent row that is in the first contiguous range and rows not indicated to have a physically adjacent row that is in the first contiguous range.

Example 9: A dynamic random access memory (DRAM) device, comprising: a memory array having rows accessed according to a physical row address range, the rows associated with one of a first type of row and a second type of row where the first type of row is to be refreshed more often than the second type of row for reliable operation of the memory array; row address mapping circuitry to map physical addresses of the first type of row to a first contiguous range of logical row addresses and to map physical addresses of the second type of row to a second contiguous range of logical row addresses, and to map external access command addresses to the first contiguous range and the second contiguous range; and refresh control circuitry to, refresh a first number of rows per refresh command for refresh operations in the first contiguous range and refresh a second number of rows per refresh command for refresh operations in the second contiguous range, where the first number is greater than the second number.

Example 10: The DRAM device of example 9, wherein the external access command addresses are associated with at least refresh, activate, and precharge commands.

Example 11: The DRAM device of example 9, wherein the memory array includes per row activation counters.

Example 12: The DRAM device of example 11, wherein the memory array includes per row metadata to indicate whether a row has a physically adjacent row that is in the first contiguous range.

Example 13: The DRAM device of example 12, wherein different row activation counter thresholds are used for rows indicated to have a physically adjacent row that is in the first contiguous range and rows not indicated to have a physically adjacent row that is in the first contiguous range.

Example 14: The DRAM device of claim 9, wherein the memory array includes per row activation counters and the memory array includes per row metadata to indicate whether a row is in the physical vicinity of a row that is in the first contiguous range.

Example 15: The DRAM device of example 9, the row address mapping circuitry selects logical-to-physical address translations to avoid simultaneous activation conflicts among respective pluralities of rows refreshed in response to refresh commands.

Example 16. A memory controller, comprising: a command/address interface to transmit at least refresh commands, activate commands, and precharge commands to a memory component, the memory component to include a dynamic random access memory (DRAM) device having a memory array having rows accessed according to a physical row address range, the rows associated with one of a first type of row and a second type of row where the first type of row is to be refreshed more often than the second type of row for reliable operation of the memory array, the memory component including row address mapping circuitry to map physical addresses of the first type of row to a first contiguous range of logical row addresses and to map physical addresses of the second type of row to a second contiguous range of logical row addresses, the row address mapping circuitry to also map external access command addresses associated with the refresh commands, activate commands, and precharge commands to the first contiguous range and the second contiguous range; and refresh control circuitry to transmit, to the memory component and via the command/address interface, refresh commands that refresh the first contiguous range and the second contiguous range at least once per retention interval, the refresh control circuitry to also transmit, to the memory component and via the command/address interface, activate and precharge command sequences to refresh the first contiguous range at least once per retention interval.

Example 17: The controller of example 16, wherein the memory component is a memory module and the row address mapping circuitry is in a registering clock driver integrated circuit of the memory module.

Example 18: The controller of example 16, wherein the activate and precharge command sequences are transmitted to refresh the first contiguous range at a rate that refreshes the first contiguous range at least a two-times refresh frequency of the first contiguous range that is not dependent on a refresh counter of the DRAM device.

Example 19: The controller of example 16, wherein the activate and precharge command sequences are scheduled to be performed by the DRAM device when the refresh commands that refresh the first contiguous range and the second contiguous range are not being performed by the DRAM device.

Example 20: The controller of example 16, wherein the memory array of the DRAM device includes per row activation counters and per row metadata to indicate whether a row has a physically adjacent row that is in the first contiguous range.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A dynamic random access memory (DRAM) device, comprising:
a memory array having rows accessed according to a physical row address range, the rows associated with one of a first type of row and a second type of row where the first type of row is to be refreshed more often than the second type of row for reliable operation of the memory array;
row address mapping circuitry to map physical addresses of the first type of rows to a first contiguous range of logical row addresses and to map physical addresses of the second type of rows to a second contiguous range of logical row addresses, and to also map external access command addresses to the first contiguous range and the second contiguous range; and
refresh address generation circuitry to, responsive to external refresh commands that are greater in number than a baseline number of refresh commands per retention interval, step through the first contiguous range at least twice per retention interval and step through the second contiguous range at least once per retention interval.

2. The DRAM device of claim 1, wherein the external access command addresses are associated with at least refresh, activate, and precharge commands.

3. The DRAM device of claim 1, wherein the refresh address generation circuitry is to step through a range of logical addresses that includes at least two instances of the first contiguous range.

4. The DRAM device of claim 3, wherein a first instance of the of the first contiguous range is inserted into the range of logical addresses that includes at least two instances of the first contiguous range such that the first instance is substantially maximally-dispersed from other instances of the at least two instances of the first contiguous range.

5. The DRAM device of claim 3, wherein the at least two instances of the first contiguous range are substantially evenly interleaved across the range of logical addresses that includes at least two instances of the first contiguous range.

6. The DRAM device of claim 1, wherein the memory array includes per row activation counters.

7. The DRAM device of claim 6, wherein the memory array includes per row metadata to indicate whether a row has a physically adjacent row that is in the first contiguous range.

8. The DRAM device of claim 7, wherein different row activation counter thresholds are used for rows indicated to have a physically adjacent row that is in the first contiguous range and rows not indicated to have a physically adjacent row that is in the first contiguous range.

9. A dynamic random access memory (DRAM) device, comprising:
a memory array having rows accessed according to a physical row address range, the rows associated with one of a first type of row and a second type of row where the first type of row is to be refreshed more often than the second type of row for reliable operation of the memory array;
row address mapping circuitry to map physical addresses of the first type of row to a first contiguous range of logical row addresses and to map physical addresses of the second type of row to a second contiguous range of logical row addresses, and to map external access command addresses to the first contiguous range and the second contiguous range; and
refresh control circuitry to, refresh a first number of rows per refresh command for refresh operations in the first contiguous range and refresh a second number of rows per refresh command for refresh operations in the second contiguous range, where the first number is greater than the second number.

10. The DRAM device of claim 9, wherein the external access command addresses are associated with at least refresh, activate, and precharge commands.

11. The DRAM device of claim 9, wherein the memory array includes per row activation counters.

12. The DRAM device of claim 11, wherein the memory array includes per row metadata to indicate whether a row has a physically adjacent row that is in the first contiguous range.

13. The DRAM device of claim 12, wherein different row activation counter thresholds are used for rows indicated to have a physically adjacent row that is in the first contiguous range and rows not indicated to have a physically adjacent row that is in the first contiguous range.

14. The DRAM device of claim 9, wherein the memory array includes per row activation counters and the memory array includes per row metadata to indicate whether a row is in the physical vicinity of a row that is in the first contiguous range.

15. The DRAM device of claim 9, the row address mapping circuitry selects logical-to-physical address translations to avoid simultaneous activation conflicts among respective pluralities of rows refreshed in response to refresh commands.

16. A memory controller, comprising:
a command/address interface to transmit at least refresh commands, activate commands, and precharge commands to a memory component, the memory component to include a dynamic random access memory (DRAM) device having a memory array having rows accessed according to a physical row address range, the rows associated with one of a first type of row and a second type of row where the first type of row is to be refreshed more often than the second type of row for reliable operation of the memory array, the memory component including row address mapping circuitry to map physical addresses of the first type of row to a first contiguous range of logical row addresses and to map physical addresses of the second type of row to a second contiguous range of logical row addresses, the row address mapping circuitry to also map external access command addresses associated with the refresh commands, activate commands, and precharge commands to the first contiguous range and the second contiguous range; and
refresh control circuitry to transmit, to the memory component and via the command/address interface, refresh commands that refresh the first contiguous range and the second contiguous range at least once per retention interval, the refresh control circuitry to also transmit, to the memory component and via the command/address interface, activate and precharge command sequences to refresh the first contiguous range at least once per retention interval.

17. The controller of claim 16, wherein the memory component is a memory module and the row address mapping circuitry is in a registering clock driver integrated circuit of the memory module.

18. The controller of claim 16, wherein the activate and precharge command sequences are transmitted to refresh the first contiguous range at a rate that refreshes the first contiguous range at least a two-times refresh frequency of the first contiguous range that is not dependent on a refresh counter of the DRAM device.

19. The controller of claim 16, wherein the activate and precharge command sequences are scheduled to be performed by the DRAM device when the refresh commands that refresh the first contiguous range and the second contiguous range are not being performed by the DRAM device.

20. The controller of claim 16, wherein the memory array of the DRAM device includes per row activation counters and per row metadata to indicate whether a row has a physically adjacent row that is in the first contiguous range.
